(19) United States
(12) Patent Application Publication
(10) Pub. No.: US 2015/0233707 A1
(43) Pub. Date: Aug. 20, 2015

(54) METHOD AND APPARATUS OF MEASURING THE SHAPE OF AN OBJECT

(71) Applicants: Jonathan Mark Huntley, Loughborough (GB); Charles Russell Coggrave, Loughborough (GB)

(72) Inventors: Jonathan Mark Huntley, Loughborough (GB); Charles Russell Coggrave, Loughborough (GB)

(73) Assignee: PHASE VISION LTD, Loughborough, Leicestershire (GB)

(21) Appl. No.: 13/821,620

(22) PCT Filed: Sep. 6, 2011
(86) PCT No.: PCT/GB2011/051665

§ 371 Date: Mar. 18, 2015

(30) Foreign Application Priority Data
Sep. 9, 2010 (GB) 1014982.1

(51) Int. Cl. G01B 11/25; G01B 11/245

(52) U.S. Cl. CPC G01B 11/254; G01B 11/245

(57) ABSTRACT

A method for determining the shape of an object comprising the steps of: illuminating the object by projecting a structured light pattern generated by a plurality of projector pixels onto the object; forming an image from a plurality of camera pixels of the object; determining the intensity distribution of the image, on a pixel by pixel basis; identifying on a pixel by pixel basis a projector pixel corresponding to a camera pixel; adjusting the intensity of the structured light pattern on a pixel by pixel basis in dependence on the intensity distribution of the image to produce an intensity adjusted structured light pattern; using the intensity-adjusted structured light pattern to determine the shape of the object.

This invention relates to a method and apparatus for measuring the shape of an object, and particularly but not exclusively to a method and apparatus for measuring the shape of an object the surface of which does not have uniform reflectivity over the whole of the surface of the object.

It is known to use structured light techniques which, for example, involve projecting fringe patterns onto an object, the shape of which is to be measured. One example of a structured light technique is the projected fringe technique in which fringes with sinusoidal intensity profiles are projected onto an object. By acquiring several images of the fringes with a camera whilst the phase of the fringes is shifted over time, the phase distribution of the fringes, and hence the height distribution of the object, can be calculated. In its simplest form, a single fringe period is arranged to span the field of view. The resulting phase then spans the range −π to π and there is a direct correspondence between the measured phase at a given pixel in the camera and the height of the corresponding point on the object surface. The accuracy of the height measurements is however normally too low and it is beneficial to increase the number of fringes spanning the field of view.

A problem known as ‘phase wrapping’ then occurs however which gives rise to ambiguities in the relationship between the measured phase and the computed height. These ambiguities can be resolved by making phase measurements with a range of different fringe periods, such as described in European patent No. 088522. In the Gray coding technique disclosed therein, binary fringe patterns with a square wave profile are projected sequentially onto the object. The period of the fringes is varied over time. At each camera pixel the corresponding sequence of measured intensity values defines uniquely the fringe order. By combining the wrapped phase value from a single set of phase shifted images with the Gray code sequence, an unwrapped phase value can therefore be obtained, which in turn gives an unambiguous depth value for that pixel.

Such techniques are appropriate if the object, the shape of which is to be measured, has a diffusely scattering surface with uniform reflection properties. Such techniques when used to measure the shape of such objects normally enable valid data to be obtained from all parts of the surface of the object that is visible to both the projector that projects the fringe patterns onto the object, and the camera that is used to record the resultant images.

Since, in practice, many engineering components do not have a surface which has uniform reflection properties across the whole of the surface, large variations in the intensity distribution of the image or images recorded by the camera from the nominal sinusoidal (in the case of the phase-shifting technique) or binary (in the case of the Gray coding technique) may be experienced.

In cases where the variation in the intensity distribution is very high, it is possible that the pixels in some regions of the camera will saturate, whereas the signal recorded by pixels in other regions of the camera will be very weak. In both of these cases, poor quality image data, or no image data at all, will be produced by those regions. This means that the overall image or images produced may not be sufficient to enable the complete shape of the entire object to be measured.

In addition, the variation in the intensity distribution recorded by the camera can induce systematic errors in the computed coordinates. This arises because each camera pixel integrates light over a region of finite size, or ‘footprint’, on the sample surface. The presence of an intensity gradient across the footprint causes more weight to be given to scattering points in the high-intensity part of this footprint than in the low-intensity part, thus giving a systematic bias to the measured phase value and hence leading to an error in the computed coordinate for that pixel. Reduction of intensity gradients would thus reduce the errors from this source.

U.S. Pat. No. 7,456,973 describes one partial solution to this problem which is known as exposure bracketing. In such a technique, measurements on the object whose shape is to be measured are repeated at different settings of a camera and/or projector. Multiple point clouds are obtained comprising one point cloud per camera/projector setting. The data set with the best camera settings for each of the pixels is then selected so that data from all the point clouds can be combined to form one optimised point cloud with a better overall dynamic range of the sensor.

A problem with this approach is that it increases the acquisition and computation time required to measure the shape of the object. If for example three different settings of the camera are used, then the total acquisition and computation time will be increased by a factor of at least three times. Furthermore, it does not reduce the intensity gradients in the image plane of the camera and so does not reduce the resulting systematic errors in the measured shape.

U.S. Pat. No. 7,570,370 discloses a method for the determination of the 3D shape of an object. The method is an iterative method requiring several iterations in order to determine the local reflectivity of an object and to then adapt the brightness of a fringe pattern projected onto the object in dependence on the local reflectivity of the object. The method disclosed in U.S. Pat. No. 7,570,370 is therefore lengthy and complicated and because it does not identify a unique correspondence between a camera pixel and a corresponding projector pixel it may not always be successful.

According to a first aspect of the present invention there is provided a method for determining the shape of an object comprising the steps of:
illuminating the object by projecting a structured light pattern generated by a plurality of projector pixels onto the object;
forming an image from a plurality of camera pixels of the object;
determining the intensity distribution of the image, on a pixel by pixel basis;
identifying on a pixel by pixel basis a projector pixel corresponding to a camera pixel;
adjusting the intensity of the structured light pattern on a pixel by pixel basis in dependence on the intensity distribution of the image to produce an intensity adjusted structured light pattern;
using the intensity-adjusted structured light pattern to determine the shape of the object.

It is to be understood that the object may be illuminated by sequentially projecting a plurality of structured light patterns onto the object and that a plurality of images may thus be formed.

The method may comprise the further step, after the step of forming an image, of recording an image.

The step of identifying projector pixels corresponding to camera pixels may be carried out after the step of determining the intensity distribution of the image as set out above, or before that step.

The structured light pattern may be projected by any suitable light projector, such as one based on a spatial light modulator.

The camera pixels may form part of any suitable device, such as a digital camera.

Because the reflectivity of the surface of the object is likely to vary across the surface of the object, if an object is illuminated with projected light having a substantially uniform intensity distribution, the intensity distribution within a resulting image will nevertheless be non-uniform due to the spatially varying reflectivity of the surface of the object. In other words, the intensity of the light measured by individual camera pixels will vary even if the object has been illuminated with projected light having a substantially uniform intensity distribution.

By means of the invention, it is possible to individually adjust the intensity of the structured light pattern on a pixel by pixel basis in order to optimise the intensity of corresponding camera pixels thus reducing the variation in intensity of the image to acceptable levels.

In particular, by means of the invention it is possible to ensure that none of, or a reduced number of, the camera pixels become saturated or unacceptably weak.

By means of the invention, therefore, an intensity adjusted structured light pattern can be produced without having to carry out lengthy iterative method steps.

The intensity of the structured light pattern may be varied by adjusting the transmittance of each projector pixel as necessary. Alternatively, if the projector is of the type that works in a binary mode, the ratio between an on time and an off time of each projector pixel may be varied in order to give the appearance of an appropriate change in transmittance of each pixel.

In one embodiment of the invention, the steps of illuminating the object with a structured light pattern and forming an image of the object, may be carried out at a first fringe sensitivity level and for a first exposure time which is lower than an operating exposure time. The intensity of the image may then be determined on a pixel by pixel basis at the first fringe sensitivity level and for the first exposure time.

In this context, fringe sensitivity is defined as the maximum number of fringes across a measurement volume used for any of the projected patterns in a given sequence.

In another embodiment of the invention, the exposure time is not varied. Instead, adjustments are made to the camera used to form and record the image, or to the projector which is used to illuminate the object. For example, the sensitivity of the camera to light may be reduced in any convenient manner, and/or, the camera aperture size could be reduced. Alternatively, or in addition, the brightness of a projector light source used to illuminate the object could be turned down. Alternatively, or in addition, the transmittance of the projector could be reduced uniformly across the projected image.

The method may comprise the further steps of identifying camera pixels having a maximum intensity that is greater than a threshold intensity;
computing an attenuation factor for each identified camera pixel; and
reducing the intensity of the projected light on a pixel by pixel basis in accordance with the attenuation factor for each identified camera pixel.

The attenuation factor is chosen to prevent saturation of camera pixels that may occur at the operating exposure time of the camera. Once an attenuation factor for each camera pixel has been computed a transmittance mask can be created, which mask determines the required intensity of the light from each projector pixel during operation of the camera.

The method may comprise the further step of illuminating the object at a second exposure time that is shorter than the first exposure time. In this way it can be arranged that some pixels which saturated at the first exposure time will no longer saturate at the new exposure time, so that an accurate attenuation factor can then be calculated for those pixels where previously it was not calculable.

This process may be repeated again at successively reduced camera exposure times until an attenuation factor has been calculated at a sufficient number of the camera pixels.

The steps of illuminating the object and forming an image may then be repeated at a second, higher, fringe sensitivity level using the transmittance mask previously created to ensure that the intensity of the projected light on a pixel by pixel basis is such that the intensity modulation of the camera pixels is substantially uniform across the image.

The shape of the object may then be determined from this image.

By means of the present invention it is therefore possible to vary the intensity of the camera pixels individually thus ensuring an optimised image. This in turn enables a more complete and accurate measurement of the shape of the object to be achieved.

The step of illuminating the object by projecting a structured light pattern generated by a plurality of projector pixels onto the object may comprise the steps of:
illuminating the object by projecting a first structured light pattern onto the object, which first structured light pattern has a first orientation;
determining a first unwrapped phase value (ψ) for a camera pixel which first phase value defines a first line on the projector pixels of constant phase value;
illuminating the object by projecting a second structured light pattern onto the object, which second structured light pattern has a second orientation different to the first orientation;
determining a second phase value (ξ) for a camera pixel which second phase value defines a second line on the projector pixels of constant phase value; and
the step of identifying on a pixel by pixel basis a projector pixel corresponding to a camera pixel comprises the step of calculating a point of intersection between the first line and the second line to thereby identify a projector pixel corresponding to a camera pixel.

Thus the correspondence between a camera pixel and a projector pixel that illuminates a region of the object that is in turn imaged onto that camera pixel may be determined uniquely and non-iteratively by projecting two structured light patterns that are not parallel to one another onto the object.

The first and second structured light patterns may each comprise a series of fringes forming a fringe pattern.

The second orientation may be orthogonal to the first orientation. Alternatively, the second orientation may form any convenient non-zero angle relative to the first orientation.

Other methods could of course be used to identify a projector pixel corresponding to a particular camera pixel. For example, in an embodiment of the invention, the step of identifying on a pixel by pixel basis, a projected pixel corresponding to a camera pixel comprises the step of:
illuminating the object by projecting a random light pattern onto the object;
recording an image of the object with the camera whilst the object is illuminated by the random light pattern;
calculating a correlation coefficient between a sub-image centred on the camera pixel and corresponding sub-images centred on projector pixels;
selecting the projector pixel that gives the maximum correlation coefficient as computed in the previous step.

According to a second aspect of the present invention there is provided an apparatus for determining the shape of an object comprising a projector for illuminating the object with projected light comprising projector pixels and forming a structured light pattern;
a camera for forming an image of the illuminated object which image is generated from a plurality of camera pixels;
a sensor for determining the intensity of the image formed on a pixel by pixel basis;
an adjuster for adjusting the intensity of the projected light on a pixel by pixel basis in dependence on the intensity of the camera pixels thereby to reduce a variation in intensity across the image;
an analyser for analysing the image to thereby determine the shape of the object.

The projector may comprise a spatial light modulator.

The apparatus may comprise a plurality of cameras and a plurality of projectors.

The invention will now be further described by way of example only with reference to the accompanying drawings in which:

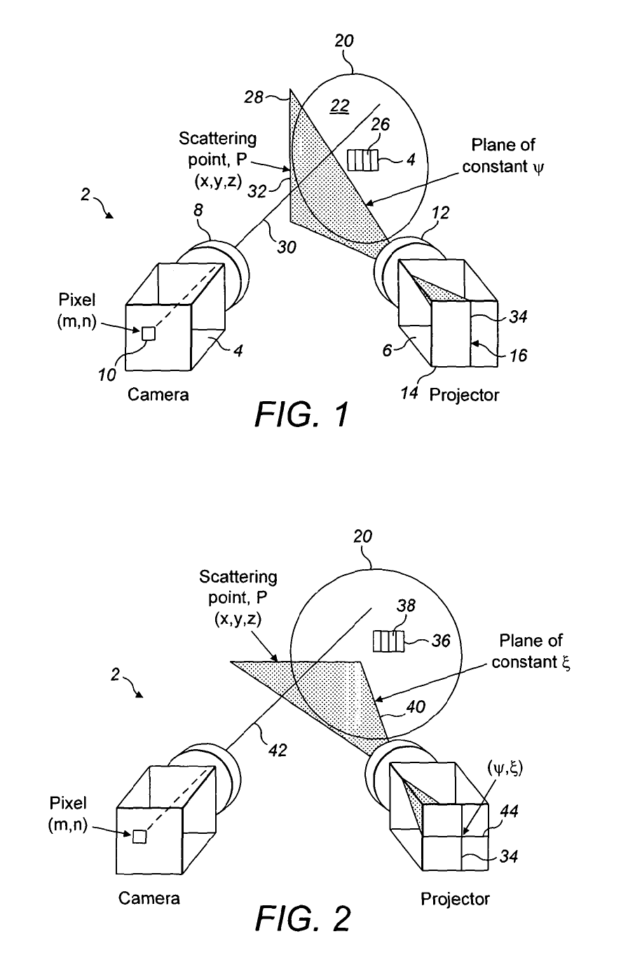

FIGS. 1 and 2 are schematic representations showing the determination of corresponding camera pixels and projector pixels according to an embodiment of the invention;

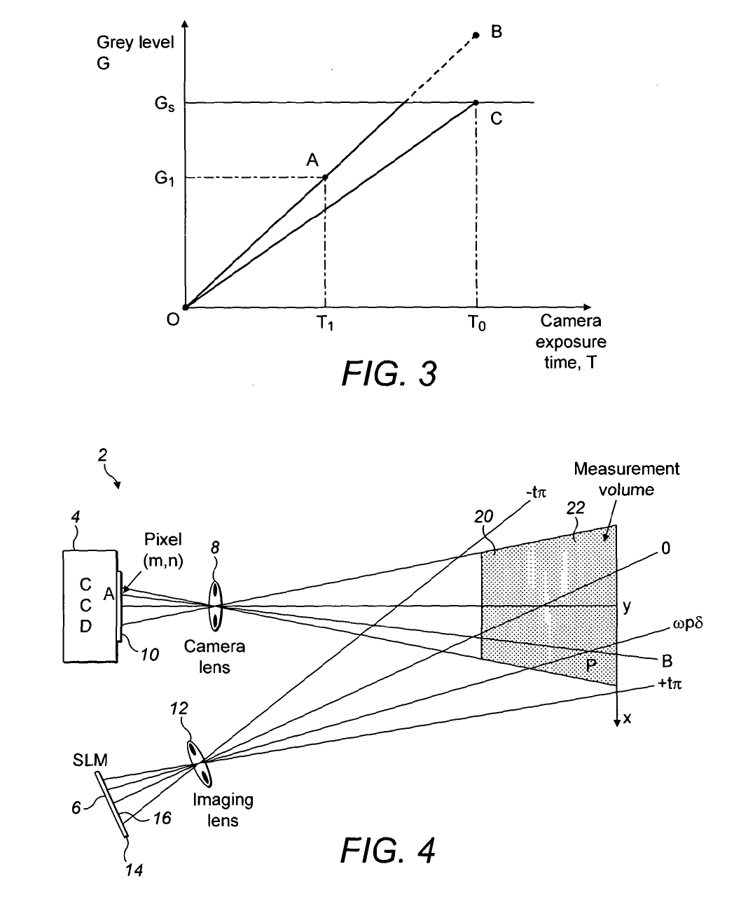

FIG. 3 is a schematic representation showing the grey level response for a known camera;

FIG. 4 is a schematic representation illustrating an embodiment of the invention;

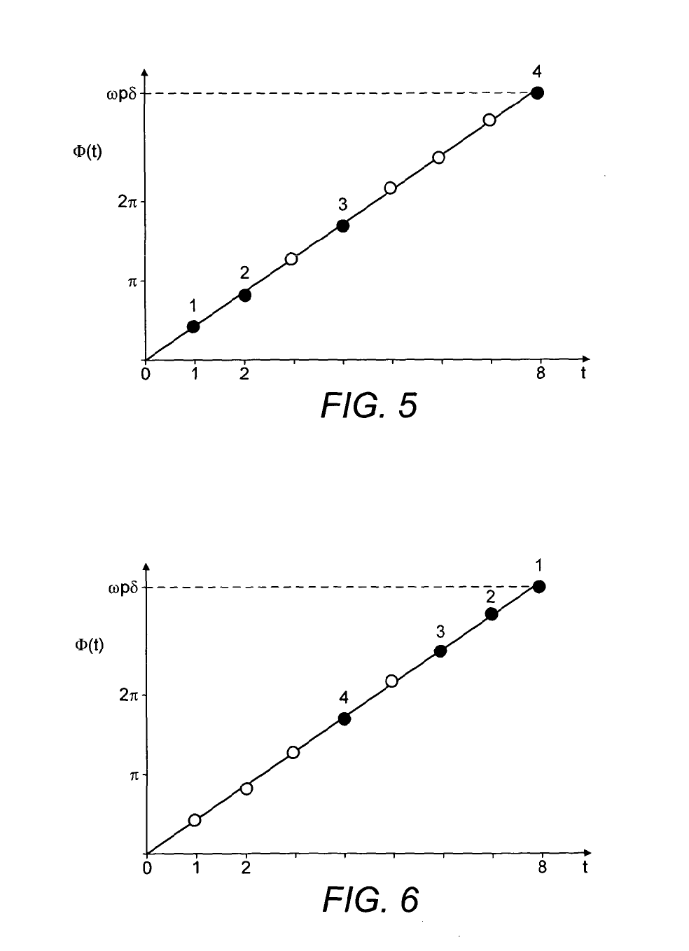

FIGS. 5 and 6 show the unwrapped phase for a given camera pixel during the light scattered by point (P) using two methods for calculating the unwrapped phase;

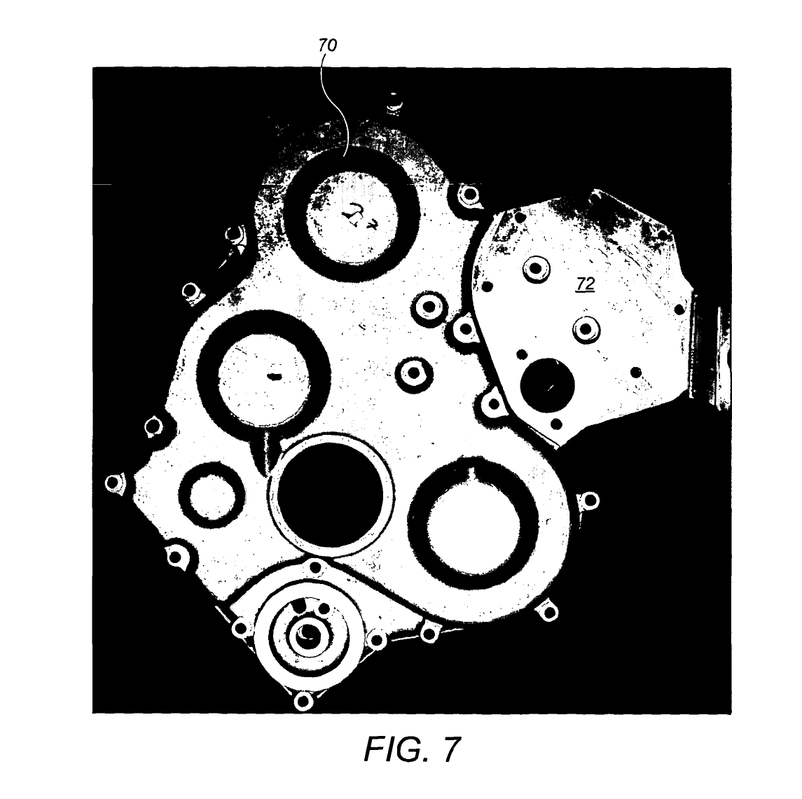

FIG. 7 is a representation of an image of a three-dimensional object illuminated using a known greyscale method;

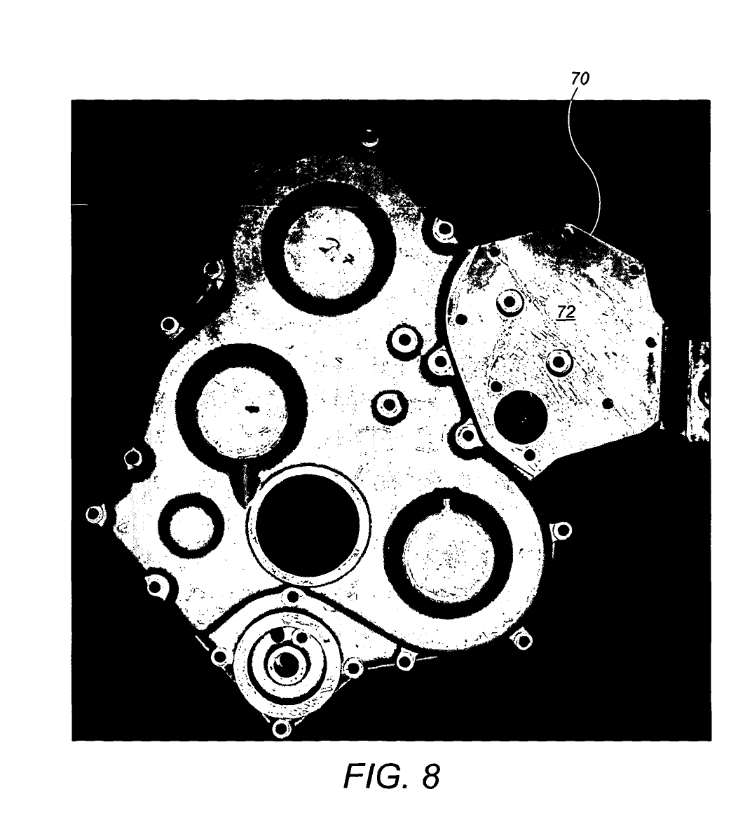

FIG. 8 is a representation of an image of a three-dimensional object obtained using a known greyscale method and further enhanced using a method according to an embodiment of the invention;

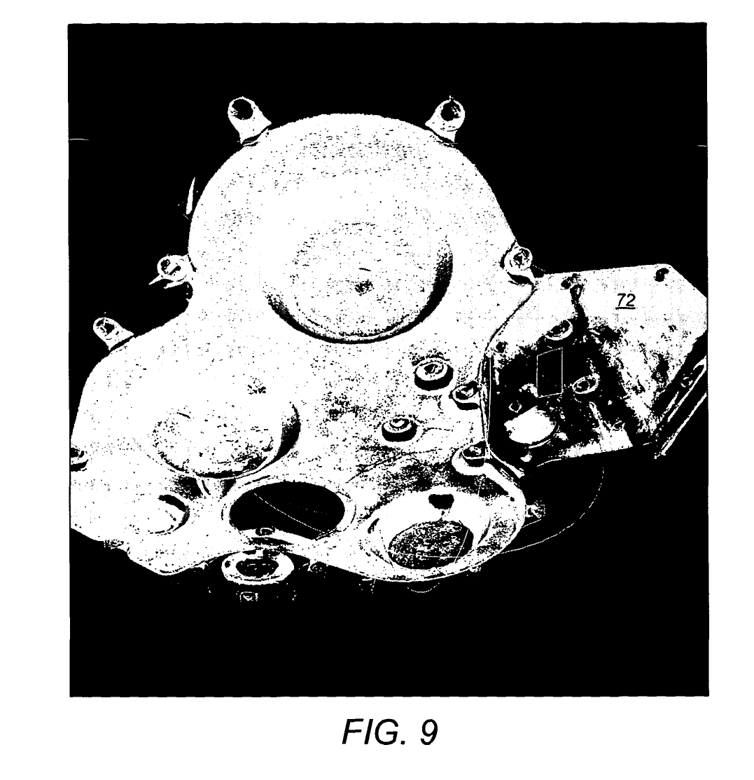

FIG. 9 is a representation of the object shown in FIG. 7;

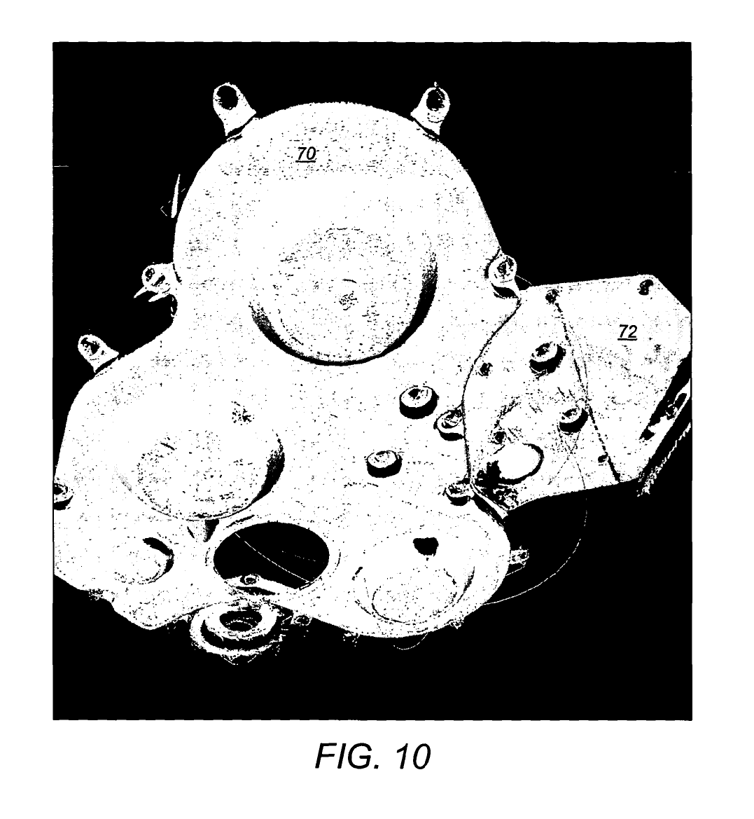

FIG. 10 is a representation of the object shown in FIG. 8, and

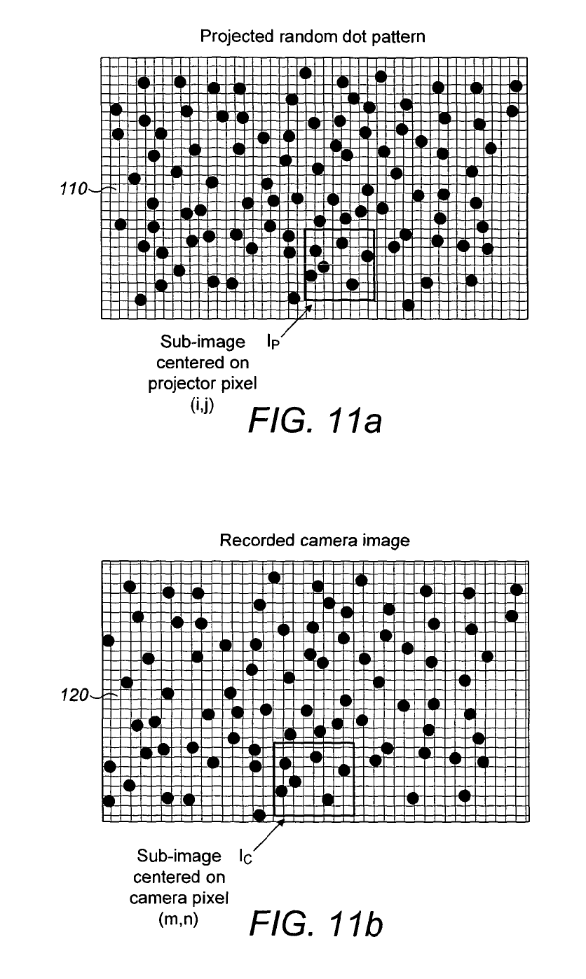

FIGS. 11a and 11b are schematic drawings illustrating the digital image correlation method of the identifying camera pixels corresponding to projector pixels.

Referring to the figures a method and apparatus according to the present invention are described.

An apparatus for measuring the shape of an object is designated generally by the reference numeral 2. The apparatus 2 comprises a camera 4 and a projector 6. The camera 4 comprises a camera lens 8 and a plurality of camera pixels 10 to record an image. The projector 6 comprises a projector lens 12 and a spatial light modulator 14 comprising a plurality of projector pixels 16. Apparatus 2 may be used to measure the shape of an object 20 having a surface 22 that has a non-uniform reflectivity.

In the description set out hereinbelow we will consider a scattering point (P) on surface 22 having spatial coordinates x, y, z. The projector 6 is adapted to project a first structured light pattern 24 to on the surface 22. In this embodiment of the invention the structured light pattern 24 comprises a series of fringes 26. In the embodiment illustrated, the camera 4 and the projector 6 are located in a horizontal plane, and the light pattern 24 is in the form of vertical fringes.

If the scattering point (P) that is imaged onto a camera pixel 10 has a high reflectivity, the pixel 10 becomes saturated. It is therefore desirable to reduce the intensity of the light from the projector 6 that illuminates the point (P) in order that the intensity of the pixel 10 may be reduced.

According to the invention, the unwrapped phase value ψ of scattering point (P) is determined. The measured value of ψ at camera pixel 10 defines a first plane 28 in three-dimensional space on which P must lie, and a corresponding line 34 (in this case a column) of pixels 16 in the spatial light modulator 14 through which the light must have passed. At this stage, it is not possible to determine the coordinates of the projector pixel 16 corresponding to the camera pixel 10, since it is possible only to determine that the projector pixel lies somewhere on a line 34 comprising a vertical column of projector pixels 16 lying in the image plane of the projector.

In order to uniquely define the appropriate projector pixel, the object 20 is illuminated by a second structured light pattern 36 which in this embodiment comprises a second series of fringes 38 having an orientation different to the orientation of the first series of fringes. In this embodiment, the second series of fringes is orthogonal to the first series of fringes and is thus substantially horizontal. A second phase value is obtained at camera pixel 10 which defines a second plane 40 in three-dimensional space on which P must lie, and a corresponding line 44 (in this case a row) of pixels 16 in the spatial light modulator 14 through which the light must have passed. The intersection of the two lines 34, 44 defines a point in the image plane of the projector which identifies the particular projector pixel whose transmittance is to be modified.

These steps are repeated for each camera pixel that images a scattering point (P) in order that each camera pixel is paired with a corresponding projector pixel. In some embodiments, however, these steps may be repeated for some, but not all of the camera pixels.

Once this process has been completed, there may be some projector pixels that have not been associated with any camera pixel. For these projector pixels, an attenuation factor may be computed by interpolating the attenuation factors from neighbouring projector pixels that have been associated with individual camera pixels.

Although the fringes illustrated in FIGS. 1 and 2 are orthogonal to one another, they do not necessarily have to be orthogonal, and two fringe patterns separated by a different angle could also be used.

The steps that have been identified hereinabove are known as phase shifting measurements and are used to identify corresponding camera pixels and projector pixels. Other methods could also be used such as the Gray Code method, or digital image correlation.

The latter method is commonly used for measuring displacement fields from two images of an object undergoing deformation, as described for example in:

Chu T. C., Ranson W. F., Sutton M. A. and Peters W. H., “Applications of digital-image-correlation techniques to experimental mechanics”, Experimental Mechanics 25 232-244 (1985); Sjodahl, M, “Electronic speckle photography increased accuracy by nonintegral pixel shifting”, Applied Optics 33 6667-6673 (1994). This method could be adapted for the current situation by projecting a random pattern onto the object, and correlating sub-images of the recorded image with the original projected image to establish a unique mapping between a small cluster of camera pixels and a corresponding small cluster of projector pixels. This method is illustrated in FIGS. 11a and 11b. FIG. 11a shows a random pattern of dots 110 which is displayed on a spatial light modulator and projected onto the object to be measured. If the object is reasonably continuous the dot pattern 120 recorded by a camera, as shown in FIG. 11b, can be compared with the dot pattern 110 projected through the projector's SLM through a process of cross correlation.

In the example shown in FIGS. 11a and 11b, the sub-images I_{P} and I_{C} from the camera and projector centred respectively on projector pixel (i, j) and camera pixel (m, n) would have a high correlation coefficient allowing one to identify unambiguously the correspondence between projector pixel (i, j) and camera pixel (m, n).

An advantage of this approach over the phase-shifting method is that only one pattern need be projected to identify corresponding camera and projector pixels. However it has a drawback in that it requires the object surface to be continuous over the scale of the sub-images in order to establish a reliable cross-correlation and hence an unambiguous correspondence between camera and projector pixels.

For this reason a method based on phase shifting may be preferred to one based on cross correlation. A particularly suitable method based on the phase shifting technique is described in European patent No. EP 088522. This method will be described in more detail herein below.

The phase shifting measurements are initially carried out at a reduced fringe sensitivity level in order to reduce the number of images compared to the number required at the operating fringe sensitivity, and hence reduce both the acquisition time and computation time. In addition the measurements are carried out with a camera exposure time T₁ that is lower than the operating exposure time T₀ in order to reduce the fraction of camera pixels that are over exposed.

An example of the response of a typical camera pixel is shown in FIG. 3, where the vertical axis represents the recorded grey level, G, and the horizontal axis represents the exposure time, T, of the camera. The gradient of this line is equal to the intensity of the light falling onto the camera pixel when the intensity is expressed in units of grey levels per unit exposure time. In this example, the grey level G₁ recorded at an exposure time of T₁ (point A) is within the linear range of the camera and the intensity can be calculated as I=G₁/T₁. If the exposure time is increased to T₀, however, the grey level that should be achieved (point B) lies beyond the linear range of the camera and the result is a saturated pixel from which valid data cannot be obtained. Gₛ is used to denote the grey level which lies just below the saturation threshold. By attenuating the light from the projector to give a modified intensity I′=Gₛ/T₀, corresponding to point C, saturation of the pixel is prevented. The required attenuated intensity may be expressed as I′=γI, where γ is an attenuation factor given by I′/I=GₛT₁/G₁T₀.

After the phase-shifted measurements at an exposure time T₁ have been carried out, the camera pixels that would saturate with an operating exposure time T₀ are identified as those whose grey level lies below Gₛ but above T₁Gₛ/T₀. For those identified pixels, an attenuation factor γ is computed where γ equals GₛT₁/G₁T₀, where G₁ is the maximum recorded grey level at that pixel from the sequence of phase-shifted images for the exposure time of T₁, and Gₛ is the grey level just below that which will cause saturation of the pixel.

T₀ is an exposure time chosen to ensure adequate signal to noise ratio in the darker parts of the object the shape of which is being measured.

From the computed values of ψ, ξ for each of these identified camera pixels, the corresponding projector pixel is identified.

The transmitted light intensity at each projector pixel corresponding to an identified camera pixel is then multiplied by the factor γ calculated at the corresponding camera pixel as explained hereinabove in order to ensure that the subsequent measurement with an operating exposure time of T₀ will not cause saturation of any camera pixels.

Finally, a normal high resolution measurement of the object is carried out using the computed attenuation mask applied to the fringe patterns displayed by the projector.

In an alternative embodiment of the invention, the phase shifting measurements may be taken at a set of second exposure times, T₁ₐ, T_{1b}, . . . T₁ₙ. These exposure times could be predetermined, for example by reducing the exposure time by a constant factor β on each successive measurement. If for a given pixel the intensity saturates at an exposure time of T₁ⱼ, but not for an exposure time of T₁ₖ=T₁ⱼ/β, then the grey level G₁ₖ recorded at the exposure time of T₁ₖ would be used to calculate the attenuation factor γ.

In other embodiments of the invention there may be more than one camera and/or more than one projector.

In such situations, it will generally be necessary for each camera/projector pair to have its own attenuation mask which will be computed by carrying out the steps described hereinabove. This is because the effective reflectivity of a given point on the object to be measured will normally be dependent on the viewing angle. This means that an attenuation mask designed for one camera will not necessarily be effective when the sample is viewed from a different camera but with the same projector. Similarly if the sample and/or sensor is mobile then a new attenuation mask will need to be determined after each movement of the sample and/or sensor.

Set out below are more details of how the phase shifting measurements can be carried out.

The method will be described with particular reference to FIGS. 4, 5 and 6.

The following description is based on the method described in Saldner, H. O. and Huntley J. M. “Profilometry by temporal phase unwrapping and spatial light modulator-based fringe projector”, Opt. Eng. 36 (2) 610-615 (1997).

The fringes are generated so that the intensity of the light passing through the SLM pixel coordinate (i, j) (i=0, 1, 2, . . . , Nᵢ−1; j=0, 1, 2, . . . , Nⱼ−1) is given by

$$I ( i , j , k , t ) = {I}_{0} + {I}_{M} cos \{ 2 π [ \frac{t ( i - {N}_{i} / 2 )}{{N}_{i}} + \frac{k - 1}{{N}_{k}} ] \} \qquad ( 1 )$$

where I₀ is the mean intensity, I_{M} is the fringe modulation intensity, k is the phase step index (k=1, 2, . . . , Nₖ, where Nₖ is the number of phase shifts—typically 4), and t is the fringe pitch index which defines the number of fringes across the array.

For any given value of t, Nₖ phase shifted patterns are written to the spatial light modulator according to Eqn. (1) and projected onto the object by the projector. For each of these patterns an image of the object is acquired by the camera. At each camera pixel the phase of the projected fringes is calculated according to standard formulae. For example, the well-known four-frame formula (Nₖ=4) uses four intensity values (Iₖ, for k=1, 2, 3, 4) measured at a given pixel to calculate a phase value for that pixel:

$${Φ}_{w} ( t ) = {tan}^{- 1} ( \frac{{I}_{4} - {I}_{2}}{{I}_{1} - {I}_{3}} ) \qquad ( 2 )$$

The subscript w is used to denote a phase value that is wrapped onto the range −π to +π by the arc-tangent operation. For the case t=1 (a single fringe across the field of view), the measured wrapped phase and the true unwrapped phase are identical because the true phase never exceeds the range −π to +π. For larger values of t, however, the measured wrapped phase and the true unwrapped phase differ in general by an integral multiple of 2π. If we use s to denote the maximum value of t, then by measuring Φ_{w} for t=1, 2, 3, . . . , s it is possible to compute a reliable unwrapped phase value for that pixel, which we denote here ψ. The total number of images required for this linear sequence of t values is s×Nₖ, which may typically be 64×4=256 images. This is therefore a time consuming process, and alternative techniques have been developed based on a subset of this linear sequence (see, for example, Huntley J. M. and Saldner, H. O. “Error reduction methods for shape measurement by temporal phase unwrapping”, J. Opt. Soc. Am. A 14 (12) 3188-3196 (1997).) The forward and reversed exponential sequences use t values that change exponentially from either the minimum or maximum t value, respectively (see FIGS. 5 and 6). The reversed exponential method reduces the acquisition time to (1+log₂s)×Vₖ=7×4=28 images, nearly an order of magnitude less than the linear sequence.

As shown in FIG. 4, the computed unwrapped phase ψ varies from −tπ for scattering points lying anywhere on a plane on one side of the measurement volume and illuminated by light that passed through column 0 (i=0) of the SLM, to a value close to +tπ for those scattering points on a plane on the other side of the measurement volume and illuminated by light that passed through column Nᵢ−1 (i=Nᵢ−1) of the SLM.

Because all the pixels in a given column produce exactly the same set of intensity values according to Eqn. (1) it is not possible from the calculated phase value at a given camera pixel to determine which SLM pixel in that column the light passed through. In effect, the measured phase value defines a line on the spatial light modulator which lies parallel to the columns. In order to determine which pixel within the column needs to have its transmittance adjusted, a second sequence of intensity values is projected with the fringe patterns rotated through 90°, although in other embodiments the fringe patterns may be rotated by a different angle.

$$I ( i , j , k , t ) = {I}_{0} + {I}_{M} cos \{ 2 π [ \frac{t ( j - {N}_{j} / 2 )}{{N}_{j}} + \frac{k - 1}{{N}_{k}} ] \} \qquad ( 3 )$$

If the measured unwrapped phase value at the given camera pixel with these rotated fringes is denoted ξ, then ξ defines a line of pixels, in this case a row, on the spatial light modulator, through which the illuminating light must have passed. The intersection of the two lines occurs at a point which is the only SLM pixel that is consistent with the measured values of both ψ and ξ. In this way the SLM pixel whose transmittance needs to be adjusted can be identified uniquely and directly (non-iteratively) for each pixel in the image plane of the camera.

Note that it is desirable to use a high value for s (the maximum number of fringes across the field of view) when measuring the shape of an object because this maximizes the signal to noise ratio in the measured coordinates. However, for the purpose of identifying the mapping between camera pixels and projector pixels described above, such high precision is not normally needed. A lower value of s can therefore be used for this phase of the algorithm, thus reducing the acquisition and computation time. In many cases, a value of s=1 is sufficient, in which case the number of acquired frames is reduced to Nₖ per fringe orientation, i.e. typically 8 frames total in place of the 56 that would be required by the reversed exponential method or 512 frames by the linear sequence.

Referring now to FIGS. 7 to 10, the invention will be further explained.

FIG. 7 is a photograph showing a three-dimensional object 70 that has been illuminated to show greyscale texture. It can be seen that in some cases there is saturation of the image for example in the area identified by reference numeral 72 which is very bright compared to other parts of the object 70. When data is obtained of the object 70 after such illumination, the parts of the object that have been overexposed, or saturated will not be accurately reproduced and therefore it is not possible to accurately ascertain the three-dimensional shape of the object 70 in areas such as area 72. This is shown as a 3D mesh plot in FIG. 9 where light grey indicates the presence of a measured coordinate and dark grey indicates either the absence of the sample surface, or else a region on the sample that is unmeasurable due to either under or over exposure. The large fraction of dark grey points on surface 72 is a direct result of the overexposure of this region of the sample as shown in FIG. 7.

Turning now to FIG. 8, an image of a three-dimensional object 70 that has been illuminated using a method according to an embodiment of the present invention is shown. It can be seen that the area 72 is now no longer overexposed, or saturated, and that the intensity of illumination over the object 70 as a whole is more uniform.

As can be seen from FIG. 10, this means that the shape of the object 70 may be measured more completely, and in particular the surface 72 now has a much smaller fraction of unmeasurable points, as indicated by the smaller fraction of dark grey points in this region of the object.

1. A method for determining the shape of an object comprising:
illuminating the object by projecting a structured light pattern generated by a plurality of projector pixels onto the object;
forming an image from a plurality of camera pixels of the object;
determining the intensity distribution of the image, on a pixel by pixel basis;
identifying on a pixel by pixel basis a projector pixel corresponding to a camera pixel;
adjusting the intensity of the structured light pattern on a pixel by pixel basis in dependence on the intensity distribution of the image to produce an intensity adjusted structured light pattern; and
using the intensity-adjusted structured light pattern to determine the shape of the object.

2. A method according to claim 1 further comprising recording the image, after the step of forming the image.

3. A method according to claim 1 wherein the adjusting the intensity of the structured light pattern further comprises adjusting the intensity of one or more projector pixels.

4. A method according to claim 1 wherein the adjusting the intensity of the structured light pattern further comprises varying a ratio of an on time and an off time of each projector pixel.

5. A method according to claim 1 wherein the illuminating the object with a structured light pattern, and the forming an image from a plurality of camera pixels are carried out at a first fringe sensitivity level and for a first exposure time which is lower than an operating exposure time.

6. A method according to claim 5 further comprising:
identifying camera pixels having a maximum intensity that is greater than a threshold intensity;
computing an attenuation factor for each identified camera pixel; and
reducing the intensity of the projected light on a pixel by pixel basis in accordance with the attenuation factor for each identified camera pixel.

7. A method according to claim 5 further comprising illuminating the object with a structured light pattern at the first fringe sensitivity level and at a second, shorter exposure time than the first exposure time.

8. A method according to claim 5 wherein the illuminating the object and the forming an image are repeated at a second, higher, fringe sensitivity level.

9. A method according to claim 1 wherein the illuminating the object by projecting a structured light pattern generated by a plurality of projector pixels onto the object further comprises:
illuminating the object by projecting a first structured light pattern onto the object, which first structured light pattern has a first orientation;
determining a first unwrapped phase value for a camera pixel, which first phase value defines a first line on the projector pixels of constant phase value;
illuminating the object by projecting a second structured light pattern onto the object, which second structured pattern has a second orientation different to the first orientation;
determining a second phase value for a camera pixel, which second phase value defines a second line on the projector pixels of constant phase value; and
the identifying on a pixel by pixel basis a projector pixel corresponding to a camera pixel further comprises:
calculating a point of intersection between the first line and the second line to thereby identify a projector pixel corresponding to an camera pixel.

10. A method according to claim 1 wherein the identifying on a pixel by pixel basis a projector pixel corresponding to a camera pixel further comprises:
illuminating the object by projecting a random light pattern onto the object;
recording an image of the object with the camera whilst the object is illuminated by the random light pattern;
calculating a correlation coefficient between a sub-image centred on the camera pixel and corresponding sub-images centred on projector pixels; and
selecting the projector pixel that gives the maximum correlation coefficient based on the calculating.

11. An apparatus for determining the shape of an object comprising:
a projector that illuminates the object with projected light forming a structured light pattern;
a camera that forms an image of the illuminated object which image comprises a plurality of camera pixels;
a sensor that determines the intensity of the image formed on a pixel by pixel basis;
an adjuster that adjusts the transmittance of the projected light on a pixel by pixel basis in dependence on the intensity of the camera pixel thereby to reduce the variation in intensity across the image; and
an analyzer that analyzes the image to thereby determine the shape of the object.

12. An apparatus according to claim 11 wherein the projector further comprises a spatial light modulator comprising a plurality of projector pixels.

13. An apparatus according to claim 11 wherein the camera further comprises a plurality of cameras and the projector further comprises a plurality of projectors.

14-15. (canceled)
